(19) United States
(12) Patent Application Publication
(10) Pub. No.: US 2026/0042924 A1
(43) Pub. Date: Feb. 12, 2026

(54) INK-JET INK OPTIMIZED IN TERMS OF CROSS-LINKED RESIN AND ALKALI METAL ION CONCENTRATION

(71) Applicant: KYOCERA Document Solutions Inc., Osaka (JP)

(72) Inventors: Masatoshi NAKAGOMI, Osaka (JP); Mitsuko MIYATA, Osaka (JP); Haruhiro HATAJIRI, Osaka (JP)

(73) Assignee: KYOCERA Document Solutions Inc., Osaka (JP)

(21) Appl. No.: 19/289,102

(22) Filed: Aug. 4, 2025

(30) Foreign Application Priority Data
Aug. 6, 2024 (JP) 2024-130223

(51) Int. Cl. C09D 11/322; C09D 11/037; C09D 11/107

(52) U.S. Cl. CPC C09D 11/322; C09D 11/037; C09D 11/107

(57) ABSTRACT

In an ink-jet ink, a pigment is a quinacridone-based pigment. A specific resin is a neutralized product of a specific copolymer containing α-methylstyrene-derived units, styrene-derived units, (meth)acrylic acid-derived units, and (di)alkylene glycol (meth)acrylate-derived units in respective predetermined amounts, wherein an acid value of the specific copolymer is not less than 50 mgKOH/g and not more than 300 mgKOH/g, and a number average molecular weight (Mn) of the specific copolymer is not less than 3000 and not more than 18000. The specific resin has a percentage of neutralization of not less than 20% and not more than 100%. A specific cross-linking agent contains a polyfunctional epoxy compound and has a water solubility of not less than 80%. A cross-linked resin has a cross-linking rate of not less than 25% and not more than 90%. A concentration of alkali metal ions in an aqueous vehicle is not more than 500 ppm.

### INCORPORATION BY REFERENCE

This application claims priority to Japanese Patent Application No. 2024-130223 filed on 6 Aug. 2024, the entire contents of which are incorporated by reference herein.

### BACKGROUND

The present disclosure relates to ink-jet inks.

Ink-jet inks have been improved variously in order to maintain their stable quality over a long period of time. For example, a first technique is known for adjusting the total concentration of Na ions and K ions contained in ink to not more than 500 ppm or adjusting the total concentration of sulfuric acid ions, chlorine ions, and nitric acid ions in the ink to not more than 500 ppm. Furthermore, a second technique is known for adjusting the amount of cations in ink to less than 200 mM.

### SUMMARY

A technique improved over the aforementioned techniques is proposed as one aspect of the present disclosure.

An ink-jet ink according to an aspect of the present disclosure contains an aqueous vehicle and pigment particles dispersed in the aqueous vehicle. The pigment particle contains a pigment and a cross-linked resin. The pigment is a quinacridone-based pigment. The cross-linked resin is a cross-linked product made of a specific resin and a specific cross-linking agent. The specific resin is a neutralized product of a specific copolymer having first repeating units derived from α-methylstyrene, second repeating units derived from styrene, third repeating units derived from (meth)acrylic acid, and fourth repeating units derived from alkylene glycol (meth)acrylate or dialkylene glycol (meth)acrylate. The specific copolymer has, relative to 100% by mass of all of the first to fourth repeating units, a content of the first repeating unit of not less than 1% by mass and not more than 65% by mass, a content of the second repeating unit of not less than 1% by mass and not more than 60% by mass, a content of the third repeating unit of not less than 10% by mass and not more than 40% by mass, and a content of the fourth repeating unit of not less than 1% by mass and not more than 12% by mass. The specific copolymer has an acid value of not less than 50 mgKOH/g and not more than 300 mgKOH/g. The specific copolymer has a number average molecular weight of not less than 3000 and not more than 18000. The specific resin has a percentage of neutralization of not less than 20% and not more than 100%. The specific cross-linking agent contains a polyfunctional epoxy compound having, in a molecule thereof, two or more epoxy groups and one or more hydroxy groups and has a water solubility of not less than 80%. The cross-linked resin has a cross-linking rate of not less than 25% and not more than 90%. A concentration of alkali metal ions in the aqueous vehicle is not more than 500 ppm.

### DETAILED DESCRIPTION

Hereinafter, a description will be given of an ink-jet ink (hereinafter, referred to simply as an “ink”) according to an embodiment of the present disclosure. In the following description, “acrylic” and “methacrylic” may be referred to collectively as “(meth)acrylic”, and “acrylate” and “methacrylate” may be referred to collectively as “(meth)acrylate”.

Furthermore, a compound and its derivatives may be referred to collectively by a term in which a word “-based” is placed just after the name of the compound. When a copolymer name is represented by placing the word “-based” just after the name of a compound, this means that a repeating unit of the copolymer is derived from the compound or any derivative of the compound.

In this embodiment, the acid value refers to a value determined according to the method described in JIS (Japanese Industrial Standards) K 0070:1992.

The measured value of the number average molecular weight (Mn) refers to a value measured using gel permeation chromatography (GPC).

The volume median diameter (D50) refers to a value measured with a dynamic light scattering particle size distribution analyzer (“Zetasizer Nano ZS” manufactured by Malvern Instruments, Ltd.).

The percentage of neutralization of a resin refers to the percentage of MB with respect to MA (100 × MB/MA) where MA represents a theoretical value of the amount of basic compound necessary to fully neutralize the resin and MB represents the actual amount of basic compound used.

The cross-linking rate refers to the percentage of the number of functional groups forming a cross-linked structure in a cross-linked resin to the total number of functional groups (groups reactable with a cross-linking agent) contained in a copolymer which is a source material of the cross-linked resin, when the total number of functional groups in the copolymer is assumed to be 100. The specific cross-linking agent for use in the ink according to this embodiment reacts mainly with acid groups (particularly, carboxy groups). Therefore, “the total number of functional groups contained in a copolymer” corresponds to the total number of acid groups contained in the copolymer. The cross-linking rate refers to a value calculated by the method described in Examples to be discussed later or methods conforming thereto.

The viscosity of ink means the viscosity thereof at 25° C. The measured value of the viscosity refers to a value measured in conformity with the method described in JIS Z 8803:2011 (Methods for viscosity measurement of liquid).

The epoxy equivalent refers to a value determined according to the method described in JIS K 7236:2009.

Each of evaluation results (values representing the shape, physical properties or so on) about powder refers to the number average of values obtained by measuring a considerable number of particles, unless otherwise specified.

### <Ink-Jet Ink>

The ink-jet ink according to this embodiment contains an aqueous vehicle and pigment particles dispersed in the aqueous vehicle. The pigment particle contains a pigment and a cross-linked resin. The pigment is a quinacridone-based pigment. The cross-linked resin is a cross-linked product made of a specific resin and a specific cross-linking agent.

The specific resin is a neutralized product of a specific copolymer having first repeating units derived from α-methylstyrene, second repeating units derived from styrene, third repeating units derived from (meth)acrylic acid, and fourth repeating units derived from alkylene glycol (meth)acrylate or dialkylene glycol (meth)acrylate.

The specific copolymer has, relative to 100% by mass of all of the first to fourth repeating units, a content of the first repeating unit of not less than 1% by mass and not more than 65% by mass, a content of the second repeating unit of not less than 1% by mass and not more than 60% by mass, a content of the third repeating unit of not less than 10% by mass and not more than 40% by mass, and a content of the fourth repeating unit of not less than 1% by mass and not more than 12% by mass.

The specific copolymer has an acid value of not less than 50 mgKOH/g and not more than 300 mgKOH/g. The specific copolymer has a number average molecular weight (Mn) of not less than 3000 and not more than 18000. The specific resin has a percentage of neutralization of not less than 20% and not more than 100%. The specific cross-linking agent contains a polyfunctional epoxy compound having, in a molecule thereof, two or more epoxy groups and one or more hydroxy groups and has a water solubility of not less than 80%. The cross-linked resin has a cross-linking rate of not less than 25% and not more than 90%. The concentration of alkali metal ions in the aqueous vehicle is not more than 500 ppm.

Meanwhile, the compositions of the inks in the general first and second techniques described previously may not be able to sufficiently reduce the occurrence of nozzle clogging, particularly when the inks contain a quinacridone-based pigment. Furthermore, the inks may not be able to obtain sufficient storage stability.

Unlike the above general techniques, since the ink according to this embodiment has the above-described composition and features, it can reduce the occurrence of nozzle clogging and has excellent storage stability. The reasons why the ink according to this embodiment exerts these effects will be described below.

### (Optimization of Cross-Linked Resin)

Generally, in order to reduce the occurrence of nozzle clogging, it is effective to give the pigment particles high dispersion stability. Although, as described above, the pigment particle contains a pigment and a cross-linked resin, the pigment alone has low dispersibility in aqueous vehicle. Therefore, in order to give the pigment particles high dispersion stability, it is necessary to increase the dispersion stability of the cross-linked resin.

The present discloser conducted intensive studies for increasing the dispersion stability of the cross-linked resin and, as a result, found that when the contents of first to fourth repeating units in the specific copolymer, the acid value of the specific copolymer, the number average molecular weight (Mn) of the specific copolymer, the percentage of neutralization of the specific resin, and the cross-linking rate of the cross-linked resin are within the above-described respective ranges of values and, in addition, the cross-linked resin is given a cross-linked structure derived from the specific cross-linking agent, the pigment particles can exert excellent dispersion stability in aqueous vehicle and, therefore, the occurrence of nozzle clogging can be reduced.

Specifically, the first to fourth repeating units in the specific copolymer have the following functions. The first repeating unit moderately increases the affinity of the cross-linked resin with the pigment particles. The second repeating unit gives the cross-linked resin moderate hydrophobicity to adjust the dispersion stability of the pigment particles. The third and fourth repeating units give the cross-linked resin moderate hydrophilicity and thus give the pigment particles dispersion stability. In the ink according to this embodiment, the respective contents of the first to fourth repeating units in the specific copolymer are optimized to enable the cross-linked resin to exert excellent dispersion stability.

In relation to the specific resin, the specific copolymer which is a source material of the specific resin has a relatively high acid value and contains a relatively large number of acid groups. The acid groups of the specific resin are moderately neutralized. The acid groups (particularly, neutralized acid groups) have high hydrophilicity. Therefore, the specific resin has a moderately high hydrophilicity. Furthermore, the specific cross-linking agent has hydroxy groups and has a high water solubility. Therefore, the specific cross-linking agent also has a moderately high hydrophilicity. Since the cross-linked resin is a cross-linked product made of the specific resin and the specific cross-linking agent, each having a moderately high hydrophilicity, the cross-linked resin has a moderately high hydrophilicity. As a result, the cross-linked resin has excellent dispersion stability in the aqueous vehicle.

Since the specific cross-linking agent has epoxy groups which are cross-linkable groups having excellent reactivity, it efficiently forms a moderate amount of cross-linked structure together with the specific resin. Furthermore, the specific copolymer which is a source material of the cross-linked resin has a suitable molecular size and, therefore, the cross-linked resin can efficiently coat the pigment particles. Thus, the separation of the cross-linked resin from the pigment particles can be suppressed, which can prevent aggregation of bare pigment particles. As a result, the pigment particles have excellent dispersion stability in the aqueous vehicle.

### (Optimization of Concentration of Alkali Metal Ions)

It is generally known that when the amount of ions in ink is large, the surface charge of the pigment particles is neutralized by the ions and, thus, the pigment particles is decreased in dispersion stability in an aqueous vehicle and becomes easily aggregable. The present discloser conducted various studies and, as a result, found that aqueous inks containing quinacridone-based pigments are particularly susceptible to the amount of ions.

The present discloser conducted intensive studies for reducing the decrease in the dispersion stability of pigment particles and, as a result, found that when the concentration of alkali metal ions in the aqueous vehicle is adjusted to not more than 500 ppm, the ejection stability and storage stability of aqueous inks containing quinacridone-based pigments can be significantly improved.

The usage of the ink according to this embodiment is not particularly limited, but, for example, the ink can be used for image formation on permeable recording media or non-permeable recording media. The ink according to this embodiment is suitable for image formation on permeable recording media. The permeable recording media have excellent ink penetration. Examples of the permeable recording media include printing paper and media made from fibers, such as fabrics. Examples of printing paper include plain paper, copy paper, recycled paper, thin paper, paperboard, and glossy paper.

Hereinafter, a more detailed description will be given of components of the ink according to this embodiment. Each of the components described below may be used as a single type of material or in combination of two or more types of materials.

### [Aqueous Vehicle]

The aqueous vehicle is a vehicle containing water. The aqueous vehicle may function as a solvent or a dispersion medium. A specific example of the aqueous vehicle is an aqueous vehicle containing water and a water-soluble organic solvent.

### (Water)

The content of water in the ink according to this embodiment is preferably not less than 25.0% by mass and not more than 80.0% by mass, and more preferably not less than 35.0% by mass and not more than 60.0% by mass.

### (Water-Soluble Organic Solvent)

Examples of the water-soluble organic solvent include a glycol compound, a triol compound, a glycol ether compound, a lactam compound, a nitrogen-containing compound, an acetate compound, thiodiglycol, and dimethylsulfoxide.

Examples of the glycol compound include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, tetraethylene glycol, and 2-ethyl-1,2-hexanediol. Among them, the preferred glycol compounds are ethylene glycol, diethylene glycol, 2-ethyl-1,2-hexanediol, 3-methyl-1,5-pentanediol, 1,3-propanediol, 1,5-pentanediol, and propylene glycol.

Examples of the triol compound include glycerin and 1,2,3-butanetriol.

Examples of the glycol ether compound include diethyl diglycol, diethylene glycol monobutyl ether, ethylene glycol monomethyl ether, ethylene glycol monobutyl ether, diethylene glycol monomethyl ether, diethylene glycol monoethyl ether, diethylene glycol diethyl ether (diethyl diglycol), triethylene glycol monomethyl ether, triethylene glycol monoethyl ether, triethylene glycol monobutyl ether, and propylene glycol monomethyl ether. Among them, the preferred glycol ether compound is triethylene glycol monobutyl ether.

Examples of the lactam compound include 2-pyrrolidone and N-methyl-2-pyrrolidone. Among them, the preferred lactam compound is 2-pyrrolidone.

Examples of the nitrogen-containing compound include 1,3-dimethyl imidazolidinone, formamide, and dimethyl formamide.

An example of the acetate compound is diethylene glycol monoethyl ether acetate.

The preferred water-soluble organic solvent is a glycol compound or a glycol ether compound and the more preferred water-soluble organic solvent is ethylene glycol or diethyl diglycol.

The content of water-soluble organic solvent in the ink according to this embodiment is preferably not less than 10.0% by mass and not more than 50.0% by mass, and more preferably not less than 30.0% by mass and not more than 40.0% by mass.

The content of glycol compound in the ink according to this embodiment is preferably not less than 5.0% by mass and not more than 45.0% by mass, and more preferably not less than 15.0% by mass and not more than 25.0% by mass.

The content of glycol ether compound in the ink according to this embodiment is preferably not less than 5.0% by mass and not more than 30.0% by mass, and more preferably not less than 10.0% by mass and not more than 20.0% by mass.

### [Pigment Particles]

As described previously, the pigment particle contains a pigment and a cross-linked resin. For example, the pigment particle is constituted by: a core containing a pigment; and a cross-linked resin that coats the core. The total content of pigment and cross-linked resin in the pigment particle is preferably not less than 90% by mass and more preferably 100% by mass.

From the viewpoint of optimizing the color density, hue or stability of the ink according to this embodiment, the volume median diameter of the pigment particles is preferably not less than 30 nm and not more than 200 nm, and more preferably not less than 80 nm and not more than 130 nm.

The content of pigment particles in the ink according to this embodiment is preferably not less than 5.0% by mass and not more than 20.0% by mass, and more preferably not less than 10.0% by mass and not more than 15.0% by mass. When the content of pigment particles is not less than 5.0% by mass, the ink according to this embodiment enables easier formation of an image having a desired image density. Furthermore, when the content of pigment particles is not more than 20.0% by mass, the fluidity of the ink can be optimized.

### (Pigment)

As described previously, the pigment is a quinacridone-based pigment. Examples of the quinacridone-based pigment include C.I. Pigment Violets (19 and 42), C.I. Pigment Reds (122, 202, 206, 207, and 209), and C.I. Pigment Oranges (48 and 49).

Examples of marketed products available as the quinacridone-based pigment include “TRM-11” manufactured by Dainichiseika Color & Chemicals Mfg. Co., Ltd., “Cinquasia (registered trademark) Magenta D4550” manufactured by BASF corporation, “Cinquasia (registered trademark) Pink D4450” manufactured by BASF corporation, “Inkjet Magenta E-S” manufactured by Clariant Corporation, “Hostaperm Pink E 02” manufactured by Clariant Corporation, “Hostaperm Red E3B” manufactured by Clariant Corporation, and “Hostaperm Red E5B 02” manufactured by Clariant Corporation.

The content of quinacridone-based pigment in the ink according to this embodiment is preferably not less than 3.0 parts by mass and not more than 20.0 parts by mass, and more preferably not less than 7.0 parts by mass and not more than 12.0 parts by mass.

The content of quinacridone-based pigment in the pigment particle is preferably not less than 50% by mass and not more than 90% by mass, and more preferably not less than 70% by mass and not more than 80% by mass.

### (Cross-Linked Resin)

As described previously, the cross-linked resin is a cross-linked product made of a specific resin and a specific resin cross-linking agent. For example, the cross-linked resin coats the pigment in the pigment particles. The cross-linking rate of the cross-linked resin is not less than 25% and not more than 90%, preferably not less than 35% and not more than 65%, and more preferably not less than 35% and not more than 45%. By adjusting the cross-linking rate of the cross-linked resin to not less than 25%, the separation of the cross-linked resin from the pigment particles can be suppressed. By adjusting the cross-linking rate of the cross-linked resin to not more than 90%, the dispersion stability of the pigment particles can be optimized.

The content of cross-linked resin in the ink according to this embodiment is preferably not less than 0.5% by mass and not more than 10.0% by mass, and more preferably not less than 2.0% by mass and not more than 4.5% by mass. When the content of the cross-linked resin is not less than 0.5% by mass, the dispersion stability of the pigment particles can be further optimized. When the content of the cross-linked resin is not more than 10.0% by mass, the production of suspended resin can be reduced.

The content of cross-linked resin in the pigment particle relative to 100 parts by mass of pigment is preferably not less than 25 parts by mass and not more than 60 parts by mass, and more preferably not less than 30 parts by mass and not more than 45 parts by mass. When the content of cross-linked resin relative to 100 parts by mass of pigment is not less than 25 parts by mass and not more than 60 parts by mass, the dispersion stability of the pigment particles can be further optimized.

### (Specific Resin)

As described previously, the specific resin is a neutralized product of the specific copolymer. The percentage of neutralization of the specific resin is not less than 20% and not more than 100%, preferably not less than 40% and not more than 95%, and more preferably not less than 50% and not more than 70%. By adjusting the percentage of neutralization of the specific resin to not less than 20% and not more than 100%, the cross-linked resin can be given a moderately high hydrophilicity and, thus, the dispersion stability of the pigment particles can be optimized.

The specific resin preferably contains alkali metal atoms. Specifically, the specific resin is preferably a neutralized product obtained by neutralizing the specific copolymer with a neutralizer containing alkali metal atoms. The alkali metal atoms are not volatilized even when the ink according to this embodiment is exposed to a dry condition. Therefore, since the specific copolymer is neutralized with a neutralizer containing alkali metal atoms, the neutralized state (hydrophilicity) of the cross-linked resin is maintained even when the ink according to this embodiment is exposed to a dry condition. The preferred alkali metal atoms are potassium atoms or sodium atoms. The preferred neutralizer is a hydroxide containing alkali metal atoms and the more preferred neutralizer is NaOH or KOH.

### (Specific Copolymer)

The specific copolymer has: first repeating units derived from α-methylstyrene; second repeating units derived from styrene; third repeating units derived from (meth)acrylic acid; and fourth repeating units derived from alkylene glycol (meth)acrylate or dialkylene glycol (meth)acrylate.

Examples of alkylene glycol (meth)acrylate include ethylene glycol (meth)acrylate, propylene glycol (meth)acrylate, and butylene glycol (meth)acrylate. Among them, the preferred alkylene glycol (meth)acrylate is ethylene glycol (meth)acrylate.

Examples of dialkylene glycol (meth)acrylate include diethylene glycol (meth)acrylate, dipropylene glycol (meth)acrylate, and dibutylene glycol (meth)acrylate. Among them, the preferred dialkylene glycol (meth)acrylate is dipropylene glycol (meth)acrylate.

In the specific copolymer, the content of the first repeating unit relative to 100% by mass of all the repeating units is not less than 1% by mass and not more than 65% by mass, preferably not less than 15% by mass and not more than 55% by mass, more preferably not less than 25% by mass and not more than 50% by mass, and even more preferably not less than 40% by mass and not more than 48% by mass. When the content of the first repeating unit is not less than 1% by mass and not more than 65% by mass, the affinity of the cross-linked resin with the pigment particles can be moderately increased and, thus, the dispersion stability of the pigment particles can be further optimized.

In the specific copolymer, the content of the second repeating unit relative to 100% by mass of all the repeating units is not less than 1% by mass and not more than 60% by mass, preferably not less than 10% by mass and not more than 40% by mass, and more preferably not less than 15% by mass and not more than 27% by mass. When the content of the second repeating unit is not less than 1% by mass and not more than 60% by mass, the cross-linked resin can be given moderate hydrophobicity and, thus, the dispersion stability of the pigment particles can be further optimized.

In the specific copolymer, the content of the third repeating unit relative to 100% by mass of all the repeating units is not less than 10% by mass and not more than 40% by mass, preferably not less than 20% by mass and not more than 35% by mass, and more preferably not less than 25% by mass and not more than 32% by mass. When the content of the third repeating unit is not less than 10% by mass and not more than 40% by mass, the cross-linked resin can be given moderate hydrophilicity and, thus, the dispersion stability of the pigment particles can be further optimized.

In the specific copolymer, the content of the fourth repeating unit relative to 100% by mass of all the repeating units is not less than 1% by mass and not more than 12% by mass, preferably not less than 4% by mass and not more than 11% by mass, and more preferably not less than 4% by mass and not more than 8% by mass. When the content of the fourth repeating unit is not less than 1% by mass and not more than 12% by mass, the cross-linked resin can be given moderate hydrophilicity and, thus, the dispersion stability of the pigment particles can be further optimized.

The specific copolymer preferably has, relative to 100% by mass of all of the first to fourth repeating units, a content of the first repeating unit of not less than 15% by mass and not more than 55% by mass, a content of the second repeating unit of not less than 10% by mass and not more than 40% by mass, a content of the third repeating unit of not less than 20% by mass and not more than 35% by mass, and a content of the fourth repeating unit of not less than 4% by mass and not more than 11% by mass.

The specific copolymer may be a random copolymer or a block copolymer. Among them, the preferred specific copolymer is a random copolymer.

The acid value of the specific copolymer is, as described previously, not less than 50 mgKOH/g and not more than 300 mgKOH/g, preferably not less than 100 mgKOH/g and not more than 200 mgKOH/g, and more preferably not less than 150 mgKOH/g and not more than 200 mgKOH/g. When the acid value of the specific copolymer is not less than 50 mgKOH/g and not more than 300 mgKOH/g, a sufficient cross-linked structure can be easily introduced into the cross-linked resin and the dispersion stability of the pigment particles can be optimized. When the acid value of the specific copolymer is not more than 300 mgKOH/g, it can be reduced that the dispersion stability of the pigment particles becomes excessively high. As a result, an image formed by the ink according to this embodiment can be given a desired image density.

The number average molecular weight (Mn) of the specific copolymer is, as described previously, not less than 3000 and not more than 18000, more preferably not less than 5000 and not more than 12000, and even more preferably not less than 8000 and not more than 10000. When the number average molecular weight (Mn) of the specific resin is not less than 3000 and not more than 18000, the cross-linked resin can efficiently coat the pigment particles and the separation of the cross-linked resin from the pigment particles can be suppressed.

The composition of the monomer which is a source material of the specific copolymer is preferably any one of Compositions 1 to 3 shown in Table 1 below. In Table 1, the values in each field indicate a preferred range of values of content [% by mass]. For example, “18-22” for styrene in Composition 1 shows that the composition contains styrene in an amount of not less than 18% by mass and not more than 22% by mass.

TABLE 1

| | | | Ethylene | Dipropylene | | |
|---|---|---|---|---|---|---|
| | | | glycol | glycol | Acrylic | Methacrylic |
| | Styrene | α-methylstyrene | acrylate | acrylate | acid | acid |
| Composition 1 | 18-22 | 38-42 | 3-7 | — | — | 23-27 |
| Composition 2 | 48-52 | 18-22 | — | 7-11 | 11-15 | — |
| Composition 3 | 13-17 | 13-17 | 0.5-2 | — | — | 18-22 |

### (Specific Cross-Linking Agent)

As described previously, the specific cross-linking agent contains a polyfunctional epoxy compound (X) having, in a molecule thereof, two or more epoxy groups and one or more hydroxy groups. Since the specific cross-linking agent has, in its molecule, two or more epoxy groups which are cross-linkable groups having excellent reactivity, it can efficiently form a cross-linked structure together with the specific resin. Since the specific cross-linking agent has, in its molecule, one or more hydroxy groups, a moderately high hydrophilicity of the cross-linked resin can be maintained.

The water solubility of the specific cross-linking agent is not less than 80%, preferably not less than 90%, and more preferably not less than 98%. By adjusting the water solubility of the specific cross-linked resin to not more than 80%, the dispersion stability of the pigment particles can be optimized.

The water solubility of the specific cross-linking agent used herein is, in the case of mixing of 10 g of the specific cross-linking agent with 90 g of water at 25° C., the rate (100 × A/10 g) of the mass A of the specific cross-linking agent dissolved in the water relative to the total amount (10 g) of the specific cross-linking agent. For example, when, as a result of mixing of 10 g of specific cross-linking agent with 90 g of water at 25° C., 9 g of specific cross-linking agent is dissolved in water and 1 g of specific cross-linking agent is not dissolved but precipitated in the water (mass A: 9 g), the water solubility is 90%.

In the polyfunctional epoxy compound (X), the number of epoxy groups in the molecule is preferably not less than 2 and not more than 8, and more preferably not less than 2 and not more than 5. In the polyfunctional epoxy compound (X), the number of hydroxy groups in the molecule is preferably not less than 1 and not more than 5, and more preferably not less than 1 and not more than 3.

The preferred polyfunctional epoxy compound (X) is glycerol polyglycidyl ether, polyglycerol polyglycidyl ether (particularly, diglycerol polyglycidyl ether or triglycerol polyglycidyl ether) or sorbitol polyglycidyl ether, and the more preferred polyfunctional epoxy compound (X) is glycerol polyglycidyl ether, diglycerol polyglycidyl ether or triglycerol polyglycidyl ether.

The specific cross-linking agent may further contain, in addition to the polyfunctional epoxy compound (X), another type of polyfunctional epoxy compound (Y). The preferred other type of polyfunctional epoxy compound (Y) is a compound (glycerin triglycidyl ether) represented by chemical formula (2) below. The total content of the polyfunctional epoxy compound (X) and glycerin triglycidyl ether in the specific cross-linking agent is preferably not less than 80% by mass, more preferably not less than 95% by mass, and even more preferably 100% by mass.

Examples of the polyfunctional epoxy compound (X) include compounds represented by chemical formulas (1), (3), (4), and (5) below. The preferred specific cross-linking agent is a mixture of a compound represented by the chemical formula (1) below and a compound represented by the chemical formula (2) below, a compound represented by the chemical formula (3) below, a compound represented by the chemical formula (4) below or a compound represented by the chemical formula (5) below. Respective compounds represented by chemical formulas (6) and (7) below are examples of epoxy compounds other than the polyfunctional epoxy compound (X).

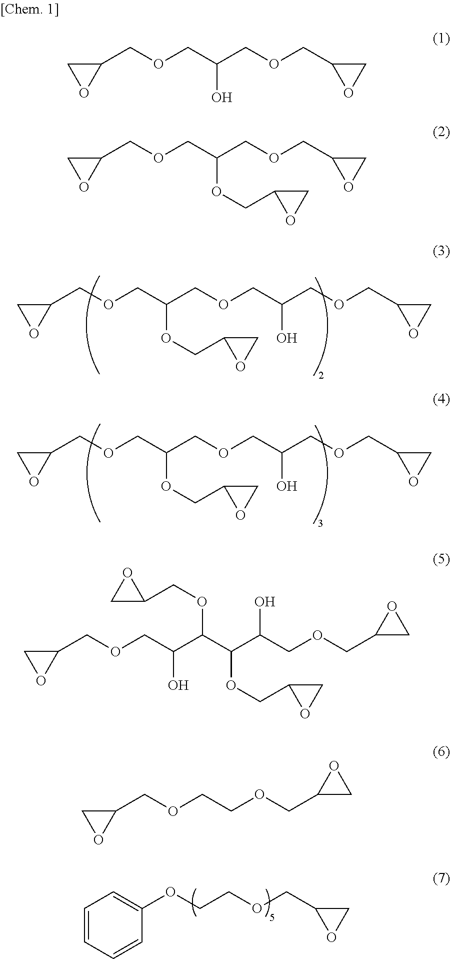

The epoxy equivalent of the specific cross-linking agent is preferably not less than 100 g/eq. and not more than 250 g/eq., more preferably not less than 130 g/eq. and not more than 200 g/eq., and even more preferably not less than 130 g/eq. and not more than 170 g/eq.

### [Alkali Metal]

As described previously, in the ink according to this embodiment, the concentration of alkali metal ions in the aqueous vehicle is not more than 500 ppm, and more preferably not more than 100 ppm.

Examples of the alkali metal include the following six elements: lithium, sodium, potassium, rubidium, cesium, and francium. Among them, the preferred alkali metal is sodium or potassium.

### [Surfactant]

The ink according to this embodiment preferably further contains a surfactant. The surfactant can optimize the penetration (wettability) of the ink according to this embodiment into a recording medium. Examples of the surfactant include an anionic surfactant, a cationic surfactant, and a non-ionic surfactant. Among them, the preferred surfactant is a non-ionic surfactant.

Examples of the non-ionic surfactant include polyoxyethylene dodecyl ether, polyoxyethylene hexadecyl ether, polyoxyethylene nonylphenyl ether, polyoxyethylene sorbitan monooleate ether, monodecanoyl sucrose, and an ethylene oxide adduct of acetylene glycol. The preferred non-ionic surfactant is an ethylene oxide adduct of acetylene glycol.

The content of surfactant in the ink according to this embodiment is preferably not less than 0.05% by mass and not more than 3.0% by mass, and more preferably not less than 0.1% by mass and not more than 0.5% by mass.

### [Other Components]

As necessary, the ink according to this embodiment may further contain a known additive (at least one of, for example, a dissolution stabilizer, an anti-drying agent, an antioxidant, a viscosity modifier, a pH adjuster, and a fungicide).

### [Content of Solid in Supernatant Liquid]

As to the ink according to this embodiment, during production or storage of the ink, the cross-linked resin may be partially separated from the pigment particles and suspended in the aqueous vehicle. Hereinafter, the cross-linked resin suspended in the aqueous vehicle as just discussed is described as suspended resin. The suspended resin functions to improve the scratch resistance of an image formed by the ink according to this embodiment, but a large amount of suspended resin may cause nozzle clogging. Therefore, the content of suspended resin in the ink according to this embodiment is preferably low. However, as to the ink according to this embodiment, the suspended resin is inevitably produced and is therefore difficult to completely remove.

In this embodiment, the solid contained in a supernatant liquid obtained by subjecting the ink according to this embodiment to centrifugation treatment, for example, at 1,050,000 G for three hours is assumed to be suspended resin. In the ink according to this embodiment, the content of solid in the supernatant liquid obtained by the centrifugation treatment is preferably not more than 2.0% by mass, more preferably not less than 0.1% by mass and not more than 1.5% by mass, and even more preferably not less than 0.5% by mass and not more than 1.0% by mass. When the above content of solid in the supernatant liquid is not more than 2.0% by mass, the occurrence of nozzle clogging due to the ink according to this embodiment can be more effectively reduced. The above content of solid can be measured by the method described in Examples to be described later or methods conforming thereto.

### <Production Method of Ink>

Next, a description will be given of an example of a method for producing the ink according to this embodiment. For example, a method for producing the ink according to this embodiment includes: a neutralization step of neutralizing a specific copolymer to prepare a specific resin; a dispersion step of dispersing a pigment and the specific resin into water to prepare a dispersion liquid of pigment particles; a cross-linking step of adding a specific cross-linking agent into the dispersion liquid of pigment particles to produce a cross-linked resin; an ion removal step of removing alkali metal ions from the dispersion liquid of pigment particles after undergoing the cross-linking treatment (or after undergoing centrifugation treatment to be described below); and an addition step of adding an aqueous vehicle into the dispersion liquid of pigment particles after undergoing the ion removal treatment to prepare an ink. The method for producing the ink according to this embodiment preferably further includes a centrifugation step of centrifuging the dispersion liquid of pigment particles after undergoing the cross-linking treatment to obtain a supernatant liquid and replacing the supernatant liquid with an aqueous medium.

### (Neutralization Step)

In the neutralization step, a specific resin is prepared by neutralizing a specific copolymer. An example of a method for neutralizing the specific copolymer is a method of mixing the specific copolymer and an aqueous solution containing a basic compound (for example, KOH or NaOH). In the neutralization step, the specific copolymer is preferably neutralized not completely but partially. Specifically, the percentage of neutralization of the specific resin is not less than 20% and not more than 100%, and preferably not less than 30% and not more than 60%.

### (Dispersion Step)

In the dispersion step, a dispersion liquid of pigment particles is prepared by dispersing a pigment and the specific resin into water. An example of a disperser for use in the dispersion step is a wet disperser, such as a medium disperser.

In the dispersion step, the content of the specific resin in a solution for use in the dispersion treatment is, for example, not less than 4.0% by mass and not more than 25.0% by mass. The content of pigment in the solution for use in the dispersion treatment is, for example, not less than 1.0% by mass and not more than 20.0% by mass. The solution for use in the dispersion treatment may further contain a defoamer. The content of defoamer in the solution for use in the dispersion treatment is, for example, not less than 0.01% by mass and not more than 0.1% by mass. In the dispersion step, foreign material and coarse particles are preferably filtered out of the obtained dispersion liquid of pigment particles using a filter (having a pore diameter of, for example, 5 μm).

### (Cross-Linking Step)

In the cross-linking step, a specific cross-linking agent is added into the dispersion liquid of pigment particles. Thus, the specific resin contained in the dispersion liquid of pigment particles reacts with the specific cross-linking agent and is thus cross-linked. As a result, a cross-linked resin is produced as a reaction product of the specific resin and the specific cross-linking agent. In the cross-linking step, it is preferred that the dispersion liquid of pigment particles after the addition of the specific cross-linking agent thereinto is heated while being stirred. The preferred heating temperature is, for example, not lower than 50° C. and not higher than 95° C. The preferred heating time is, for example, not less than 30 minutes and not more than eight hours.

### (Centrifugation Step)

In the centrifugation step, the dispersion liquid of pigment particles after undergoing the cross-linking treatment is subjected to centrifugation and the obtained supernatant liquid is replaced with an aqueous medium. Thus, suspended components contained in the aqueous medium of the dispersion liquid of pigment particles after undergoing the cross-linking treatment can be removed. In the conditions of the centrifugation treatment, for example, the rotational speed is preferably not less than 10000 rpm and not more than 100000 rpm. The centrifugation time is preferably not less than 12 hours and not more than 48 hours.

### (Ion Removal Step)

In the ion removal step, the concentration of alkali metal ions in the aqueous vehicle is adjusted by removing alkali metal ions from the dispersion liquid of pigment particles after undergoing the cross-linking treatment (or the dispersion liquid of pigment particles after undergoing the centrifugation treatment when the centrifugation treatment was done). Examples of a method for removing alkali metal ions include ion chromatography and ultrafiltration.

### (Addition Step)

In the addition step, an ink is prepared by adding an aqueous vehicle into the dispersion liquid of pigment particles after undergoing the ion removal treatment. In the addition step, as necessary, another component (specifically, at least one of a surfactant, a dissolution stabilizer, a humectant, a penetrant, and a viscosity modifier) may be further added. In the addition step, a mixture liquid obtained after the addition of the aqueous vehicle is preferably stirred with a stirrer. Furthermore, foreign material and coarse particles are preferably filtered out of the obtained ink using a filter (for example, a filter with a pore diameter of 5 μm or less).

Hereinafter, a description will be given of effects of the ink according to this embodiment with reference to examples. However, the present disclosure is not limited to the following examples.

### [Preparation of Resin (R-1)]

An amount of 100.0 parts by mass of isopropyl alcohol and 250.0 parts by mass of methyl ethyl ketone were introduced into a four-necked flask equipped with a stirrer, a nitrogen introduction tube, a condenser, and a dripping funnel. Separately, 20.0 parts by mass of styrene, 40.0 parts by mass of α-methylstyrene, 5.0 parts by mass of ethylene glycol acrylate, 25.0 parts by mass of methacrylic acid, and 0.3 parts by mass of azo-bis-isobutyronitrile (AIBN, a polymerization initiator) were mixed to prepare a monomer solution. Furthermore, 150.0 parts by mass of methyl ethyl ketone and 0.1 parts by mass of AIBN were mixed to prepare a methyl ethyl ketone solution.

Next, nitrogen gas was introduced into the above four-necked flask to place the interior of the flask under nitrogen atmosphere. Next, while the contents of the four-necked flask were heated at 70° C. to reflux, the full amount of the above monomer solution was added dropwise through the dripping funnel into the four-necked flask over two hours. After the addition of the monomer solution, the contents of the four-necked flask were further heated at 70° C. to reflux over six hours. Next, while the contents of the four-necked flask were heated at 70° C. to reflux, the full amount of the methyl ethyl ketone solution was added dropwise through the dripping funnel into the four-necked flask over 15 minutes. After the addition of the methyl ethyl ketone solution, the contents of the four-necked flask were further heated at 70° C. to reflux over five hours. Thus, a resin aqueous solution containing Resin (R-1) being a copolymer was obtained. Next, methyl ethyl ketone and isopropyl alcohol were distilled away from the resin aqueous solution to isolate Resin (R-1).

### [Preparation of Resins (R-2) to (R-19)]

Resins (R-2) to (R-19) were prepared in the same manner as in the method for preparing Resin (R-1) except that, in preparing a monomer solution, the type and amount of monomer used were changed as shown in Table 2 below. In Table 2 below, “EG acrylate” represents ethylene glycol acrylate and “DPGA” represents dipropylene glycol acrylate.

### [Measurement of Acid Value]

Each of the synthesized resins (Resin (R-1) to Resin (R-19)) was measured in terms of acid value in conformity with the method described in JIS K 0070:1992 (Test methods for acid value, saponification value, ester value, iodine value, hydroxy value and unsaponifiable matter of chemical products). The measurement results are shown in Table 2 below.

### [Measurement of Number Average Molecular Weight (Mn)]

Each of the synthesized resins (Resin (R-1) to Resin (R-19)) was measured in terms of number average molecular weight (Mn) under the conditions described below using gel permeation chromatography (GPC). The measurement results are shown in Table 2 below.

### (GPC Conditions)

Measurement device: “HLC-8020 GPC” manufactured by Tosoh Corporation
Column: ultra-high-performance semi-microcolumn for SEC (size exclusion chromatography) (“TSKgel SuperMultipore HZ-H” manufactured by Tosoh Corporation, packing material: styrene-divinyl benzene resin, column size: 4.6 mm inner diameter ×15 cm length, particle diameter of packing material: 6 μm)
Number of columns used: three
Eluent: tetrahydrofuran
Flow rate of eluate: 0.35 mL/min.
Amount of sample solution: 10 μL
Column temperature: 40° C.
Detector: RI (refractive index) detector
Calibration Curves: calibration curves created using monodisperse polystyrene standard samples (F-40, F-20, F-4, F-1, A-5000, A-2500, and A-1000) manufactured by Tosoh Corporation and n-propyl benzene
   Preparation of Resin Aqueous Solutions (r-1) to (r-19)

### (Neutralization Treatment)

Each of the resins (Resin (R-2) to Resin (R-19)) shown in Table 2 below, potassium hydroxide, and water were mixed, thus preparing Resin aqueous solutions (r-1) to (r-19). Each of the prepared Resin aqueous solutions (r-1) to (r-19) contained neutralized resin. The amount of potassium hydroxide added was adjusted to an amount at which the percentage of neutralization of each of the neutralized resins reached the value as shown in Table 2 below. The amount of water added was adjusted to an amount at which the solid concentration of each of the prepared Resin aqueous solutions (r-1) to (r-19) (i.e., the content of each of the neutralized resins) reached 30% by mass.

TABLE 2

| | | Resin aqueous solution | | | | | | |
|---|---|---|---|---|---|---|---|---|
| | | r-1 | r-2 | r-3 | r-4 | r-5 | r-6 | r-7 |
| | | Resin | | | | | | |
| | | R-1 | R-2 | R-3 | R-4 | R-5 | R-6 | R-7 |
| Monomer | Styrene | 20 | 50 | 15 | 2 | 45 | 15 | 44 |
| (parts by | α-methylstyrene | 40 | 20 | 15 | 58 | 8 | 37 | 18 |
| mass) | EG acrylate | 5 | — | 1 | 6 | — | — | 10 |
| | DPGA | — | 9 | — | — | 8 | — | — |
| | Acrylic acid | — | 13 | — | 23 | 15 | — | 10 |
| | Methacrylic acid | 25 | — | 20 | — | — | 6 | — |
| Physical | Acid value(mgKOH/g) | 181 | 110 | 255 | 171 | 155 | 67 | 93 |
| properties | Neutralization(%) | 60 | 90 | 30 | 70 | 70 | 80 | 80 |
| | NAMW (Mn) | 9600 | 10200 | 5200 | 9500 | 7600 | 6400 | 8700 |

| | | Resin aqueous solution | | | | | | |
|---|---|---|---|---|---|---|---|---|
| | | r-8 | r-9 | r-10 | r-11 | r-12 | r-13 | r-14 |
| | | Resin | | | | | | |
| | | R-8 | R-9 | R-10 | R-11 | R-12 | R-13 | R-14 |
| Monomer | Styrene | 63 | 60 | — | 5 | 40 | 35 | 20 |
| (parts by | α-methylstyrene | 1 | 10 | 50 | 70 | — | 35 | 40 |
| mass) | EG acrylate | 8 | 4 | 5 | — | 5 | 15 | — |
| | DPGA | — | — | — | 5 | — | — | — |
| | Acrylic acid | — | 20 | 25 | — | 20 | — | 35 |
| | Methacrylic acid | 33 | — | — | 10 | — | 30 | — |
| Physical | Acid value(mgKOH/g) | 204 | 165 | 243 | 72 | 239 | 170 | 286 |
| properties | Neutralization(%) | 70 | 70 | 70 | 70 | 70 | 70 | 70 |
| | NAMW (Mn) | 10100 | 9400 | 8400 | 10600 | 6300 | 12400 | 9300 |

| | | Resin aqueous solution | | | | |
|---|---|---|---|---|---|---|
| | | r-15 | r-16 | r-17 | r-18 | r-19 |
| | | Resin | | | | |
| | | R-15 | R-16 | R-17 | R-18 | R-19 |
| Monomer | Styrene | 30 | 30 | 50 | 6 | 54 |
| (parts by | α-methylstyrene | 35 | 25 | 20 | 12 | 108 |
| mass) | EG acrylate | 10 | 10 | — | 2 | 14 |
| | DPGA | — | — | 9 | — | — |
| | Acrylic acid | 55 | — | 13 | — | — |
| | Methacrylic acid | — | 5 | — | 6 | 68 |
| Physical | Acid value(mgKOH/g) | 329 | 46 | 110 | 150 | 181 |
| properties | Neutralization(%) | 70 | 70 | 10 | 60 | 60 |
| | NAMW (Mn) | 12600 | 7900 | 10200 | 2800 | 26100 |

As to each of Resins (R-1) to (R-19), the respective contents (% by mass) of the first to fourth repeating units (First to Fourth) are shown in Table 3 below.

TABLE 3

| | R-1 | R-2 | R-3 | R-4 | R-5 | R-6 | R-7 |
|---|---|---|---|---|---|---|---|
| First | 44 | 22 | 29 | 65 | 10 | 64 | 22 |
| Second | 22 | 54 | 29 | 2 | 59 | 26 | 54 |
| Third | 28 | 14 | 40 | 26 | 20 | 10 | 12 |
| Fourth | 6 | 10 | 2 | 7 | 11 | 0 | 12 |
| | R-8 | R-9 | R-10 | R-11 | R-12 | R-13 | R-14 |
| First | 1 | 11 | 63 | 78 | 0 | 30 | 42 |
| Second | 60 | 64 | 0 | 6 | 62 | 30 | 21 |
| Third | 31 | 21 | 31 | 10 | 30 | 26 | 37 |
| Fourth | 8 | 4 | 6 | 6 | 8 | 14 | 0 |

| | R-15 | R-16 | R-17 | R-18 | R-19 |
|---|---|---|---|---|---|
| First | 27 | 36 | 22 | 46 | 44 |
| Second | 23 | 43 | 54 | 23 | 22 |
| Third | 42 | 7 | 14 | 23 | 28 |
| Fourth | 8 | 14 | 10 | 8 | 6 |

As shown in Tables 2 and 3, Resins (R-1) to (R-8) were copolymers having, relative to 100% by mass of all of the first to fourth repeating units, a content of the first repeating unit of not less than 1% by mass and not more than 65% by mass, a content of the second repeating unit of not less than 1% by mass and not more than 60% by mass, a content of the third repeating unit of not less than 10% by mass and not more than 40% by mass, and a content of the fourth repeating unit of not less than 1% by mass and not more than 12% by mass, having an acid value of not less than 50 mgKOH/g and not more than 300 mgKOH/g, and having a number average molecular weight (Mn) of not less than 3000 and not more than 18000. The percentage of neutralization of each of the neutralized Resins (R-1) to (R-8) was not less than 20% and not more than 100%. In other words, the neutralized Resins (R-1) to (R-8) were specific resins.

On the other hand, Resins (R-9) to (R-14) were copolymers in which the respective contents of the first to fourth repeating units fell outside the above respective ranges. Resins (R-15) and (R-16) were copolymers in which the respective contents of the first to fourth repeating units and the acid value fell outside the above respective ranges. The percentage of neutralization of the neutralized Resin (R-17) fell outside the above range. Resins (R-18) and (R-19) were copolymers in which the number average molecular weight (Mn) fell outside the above range. In other words, the neutralized Resins (R-9) to (R-19) were resins not falling under the category of the specific resin.

### <Preparation of Ink>

Inks in Examples 1 to 11 (Ex. 1 to Ex. 11) and Comparative Examples 1 to 28 (CEx. 1 to CEx. 28) were prepared in the following manners. The manufacturer and trade names of cross-linking agents used in cross-linking treatment are shown below. The chemical names, chemical formulas, epoxy equivalents, and water solubilities of the cross-linking agents are shown in Table 4 below. In Table 4 below, “(1)+ (2)” in Chemical Formula for the cross-linking agent (EX-313) means that the cross-linking agent contains a compound represented by the chemical formula (1) described below and a compound represented by the chemical formula (2) described below.
Cross-linking agent (EX-313): “DENACOL (registered trademark) EX-313” manufactured by Nagase ChemteX Corporation
Cross-linking agent (EX-512): “DENACOL (registered trademark) EX-512” manufactured by Nagase ChemteX Corporation
Cross-linking agent (EX-521): “DENACOL (registered trademark) EX-521” manufactured by Nagase ChemteX Corporation
Cross-linking agent (EX-614B): “DENACOL (registered trademark) EX-614B” manufactured by Nagase ChemteX Corporation
Cross-linking agent (EX-612): “DENACOL (registered trademark) EX-612” manufactured by Nagase ChemteX Corporation
Cross-linking agent (EX-810): “DENACOL (registered trademark) EX-810” manufactured by Nagase ChemteX Corporation
Cross-linking agent (EX-145): “DENACOL (registered trademark) EX-145” manufactured by Nagase ChemteX Corporation

TABLE 4

| | | | Epoxy | Water |
|---|---|---|---|---|
| | | Chemical | Equivalent | Solubility |
| | Chemical Name | Formula | (g/eq.) | (% by mass) |
| EX-313 | glycerol polyglycidyl ether | (1) + (2) | 141 | 99 |
| EX-512 | polyglycerol polyglycidyl ether | (3) | 168 | 100 |
| EX-521 | polyglycerol polyglycidyl ether | (4) | 183 | 100 |
| EX-614B | sorbitol polyglycidyl ether | (5) | 173 | 94 |
| EX-612 | sorbitol polyglycidyl ether | (5) | 166 | 42 |
| EX-810 | ethylene glycol diglycidyl ether | (6) | 113 | 100 |
| EX-145 | phenol (EO)₅ glycidyl ether | (7) | 400 | 100 |

Among the above cross-linking agents, cross-linking agents (Ex-313), (EX-512), (EX-521), and (EX-614B) were specific cross-linking agents that were polyfunctional epoxy compounds having, in its molecule, two or more epoxy groups and one or more hydroxy groups and had a water solubility of not less than 80%.

### Preparation of Ink in Example 1

### (Dispersion Treatment)

An amount of 15.0 parts by mass of quinacridone-based pigment (“Cinquasia (registered trademark) Magenta D4550” manufactured by BASF Corporation), 15.0 parts by mass of Resin aqueous solution (r-1) (containing 4.5 parts by mass of neutralized Resin (R-1)), 0.1 parts by mass of defoamer (“SN-DEFOAMER 1340” manufactured by San Nopco Limited, an amide wax-based surfactant), and ion-exchange water were mixed, thus obtaining a mixture. The amount of ion-exchange water added was adjusted to an amount at which the amount of the mixture reached 100 parts by mass.

The obtained mixture was subjected to dispersion treatment for four hours with a medium disperser (“DYNO-MILL” manufactured by Willy A. Bachofen AG). In the dispersion treatment, zirconia beads with a diameter of 0.5 mm were used as a medium. The loading rate of the medium was set to 60% by volume relative to the capacity of the vessel. The treatment temperature (chiller temperature) was set to 10° C. After the dispersion treatment, the medium was removed from the contents of the medium disperser, thus obtaining a dispersion liquid of pigment particles. Next, the obtained dispersion liquid of pigment particles was filtered by a filter having a pore diameter of 5 μm, thus removing foreign material and coarse particles from the dispersion liquid.

### (Cross-Linking Treatment)

A three-necked flask equipped with a thermometer and stirring blades was used as a reactor. An amount of 100.0 parts by mass of dispersion liquid of pigment particles after undergoing the filtration was introduced into the reactor. The temperature of the contents of the reactor was maintained at 30° C. using a water bath. Next, 0.82 parts by mass of cross-linking agent (EX-313) was introduced into the reactor. Next, the contents of the reactor were stirred at 250 rpm for an hour. Next, the contents of the reactor were increased in temperature to 80° C. at a rate of temperature increase of 0.5° C./min., with stirring at 250 rpm. Next, the contents of the reactor were stirred at 250 rpm for four hours while the temperature thereof was kept at 80° C. Thus, neutralized Resin (R-1) was cross-linked with the cross-linking agent (EX-313), thus producing a cross-linked resin. Next, the contents of the reactor were allowed to cool to room temperature. Thus, the dispersion liquid of pigment particles after undergoing the cross-linking treatment was obtained.

### (Centrifugation Treatment)

The dispersion liquid of pigment particles after undergoing the cross-linking treatment was transferred to a container and this container was placed in a centrifugal adhesion force measurement device (“NS-C100” manufactured by Nano Seeds Corporation). Using the centrifugal adhesion force measurement device, the dispersion liquid of pigment particles after undergoing the cross-linking treatment was subjected to centrifugation treatment at a rotational speed of 50000 rpm over 24 hours. After the centrifugation treatment, the supernatant liquid was removed from the container and the same volume of ion-exchange water as that of the removed supernatant liquid was then added into the container. In this manner, suspended components were removed from the aqueous medium of the dispersion liquid of pigment particles after undergoing the cross-linking treatment.

### (Ion Removal Treatment)

An amount of 100 g of dispersion liquid of pigment particles after undergoing the centrifugation treatment was subjected to cycle ultrafiltration using an ultrafiltration membrane (“UF Pencil-type Module AIP-0013D” manufactured by Asahi Kasei Corporation). The ultrafiltration was conducted until the pigment concentration reached 25% by mass and the same amount of ion-exchange water as that of the filtrate was added to the dispersion liquid of pigment particles after undergoing the filtration treatment. At that time, 25% of the liquid amount of the dispersion liquid of pigment particles had been replaced with the ion-exchange water. This state is called a replacement rate of 25% for the sake of convenience.

### (Addition Treatment)

An amount of 60.0 parts by mass of dispersion liquid of pigment particles (containing approximately 9 parts by mass of pigment and approximately 3 parts by mass of Resin (R-1)) after undergoing the ion removal treatment, 20.0 parts by mass of ethylene glycol, 15.0 parts by mass of diethyl diglycol, 0.3 parts by mass of non-ionic surfactant (“OLFINE (registered trademark) E1004” manufactured by Nissin Chemical Industry Co., Ltd.), and 4.7 parts by mass of ion-exchange water were introduced into the container. The contents of the container were stirred at a rotational speed of 400 rpm using a stirrer (Three-One Motor BL-600″ manufactured by Shinto Scientific Co., Ltd.), thus obtaining a mixture liquid. The obtained mixture liquid was filtered by a filter (having a pore diameter of 5 μm). Thus, an ink in Example 1 (Ex. 1) was obtained.

### Preparation of Inks in Examples 2 to 11 (Ex. 2 to Ex. 11) and Comparative Examples 1 to 28 (CEx. 1 to CEx. 28)

Inks in Examples 2 to 11 and Comparative Examples 1 to 28 were prepared in the same manner as in the method for preparing the ink in Example 1 except that the type of pigment used, the type of resin dispersion liquid (Resin), and the type and amount of cross-linking agent used were changed as shown in Table 5 below. In Table 5 below, “E-S” represents “Inkjet Magenta E-S” manufactured by Clariant Corporation, and “E3B” represents “Hostaperm Red E3B” manufactured by Clariant Corporation. “D4550”, “E-S”, and “E3B” are all quinacridone-based pigments.

### [Calculation of Cross-Linking Rate]

As to each of the inks in Examples 1 to 11 and Comparative Examples 1 to 28, the cross-linking rate of the cross-linked resin was calculated in the following manner. For the sake of convenience, the calculation was made under the assumption that 1 part by mass equaled to 1 g. First, by dividing the amount (g) of cross-linking agent used by the epoxy equivalent (g/eq.) thereof, the mole number X of cross-linking functional groups (epoxy groups) contained in the cross-linking agent was calculated. Next, by dividing the acid value of the resin (each of Resins (R-1) to Resin (R-19)) by the molecular weight (56.1) of potassium hydroxide (KOH), the mole number of carboxy groups per gram of the neutralized resin was calculated. By multiplying the amount of the neutralized resin used in the cross-linking treatment by the mole number of carboxy groups per gram of the neutralized resin, the mole number Y of carboxy groups contained in the neutralized resin was calculated.

Using the calculated mole number X of cross-linking functional groups and the calculated mole number Y of carboxy groups, the cross-linking rate of the cross-linked resin was calculated from the following formula (1). The calculation results are shown in Table 5 below.

$$\begin{matrix}[ Math . 1 ] & \\ Cross - linking rate ( \% ) = 100 \times ( mole number X of cross - linking functional groups ) \text{} / ( mole number Y of carboxy groups ) & ( 1 )\end{matrix}$$

For example, as to the ink In Example 1, by dividing the amount of cross-linking agent (EX-313) used, 0.82 g, by the epoxy equivalent (141 g/eq.), the mole number X of cross-linking functional groups in the cross-linking agent was calculated to be 5.82 mmol. Next, by dividing the acid value (181 mgKOH/g) of Resin (R-1) by the molecular weight (56.1) of potassium hydroxide (KOH), the mole number of carboxy groups per gram of the neutralized Resin (R-1) was calculated to be 3.23 mmol/g. By multiplying the amount (4.5 g) of the neutralized Resin (R-1) used in the cross-linking treatment by the mole number (3.23 mmol/g) of carboxy groups per gram of the neutralized Resin (R-1), the mole number Y of carboxy groups contained in the neutralized Resin (R-1) was calculated to be 14.54 mmol. According to the above formula (1), the cross-linking rate of the neutralized Resin (R-1) was calculated to be 40%.

### [Measurement of Concentration of Alkali Metal Ions]

Each of the inks as subjects to measurement (each of the inks in Examples 1 to 11 and Comparative Examples 1 to 28) was centrifuged in the following manner and the obtained supernatant liquid was measured in terms of concentration of alkali metal ions.

In an environment at 23° C., 2 g of ink as a subject to measurement introduced into a hermetically sealed container was subjected to centrifugation treatment for three hours at a rotational speed of 140,000 rpm (corresponding to a centrifugal force of 1,050,000 G) with an ultracentrifuge (“himac (registered trademark) CS150FNX” manufactured by Eppendorf Himac Technologies Co., Ltd., rotor: S140AT). Thus, pigment particles contained in the subject to measurement were precipitated. An amount of 1 mL of supernatant liquid contained in the ink as the subject to measurement after undergoing the centrifugation treatment was recovered with a syringe. The recovered supernatant liquid was diluted 10-fold with water, thus obtaining a measurement sample.

The concentration of alkali metal ions in the measurement sample was measured with a radio-frequency ICP (inductively coupled plasma) mass spectrometer (“iCAP PRO ICP-OES Duo” manufactured by Thermo Fisher Scientific Inc.). Based on the obtained value, the concentration (ppm) of alkali metal ions in the supernatant liquid was determined. The measurement results are shown in Table 5 below. In determining the concentration of alkali metal ions, a calibration curve created using a sample the concentration of alkali metal ions of which had been known was used. In Table 5 below, the measurement samples in which the concentration of alkali metal ions in the supernatant liquid was not more than 500 ppm were determined as A (good), whereas the measurement samples in which the concentration of alkali metal ions in the supernatant liquid was more than 500 ppm were determined as B (poor).

TABLE 5

| | | | | Cross-linking agent | | | | | |
|---|---|---|---|---|---|---|---|---|---|
| | | | | | | Amount | | | |
| | | Resin | | | Cross- | used | | Alkali metal ion | |
| | Pigment | dispersion | | | linking | (parts by | Replacement | concentration | |
| | type | liquid | Resin | Type | rate (%) | mass) | rate(%) | ppm | Determination |
| Ex. 1 | D4550 | r-1 | R-1 | EX-313 | 40 | 0.82 | 100 | 446 | A |
| Ex. 2 | D4550 | r-2 | R-2 | EX-512 | 80 | 1.19 | 25 | 418 | A |
| Ex. 3 | D4550 | r-3 | R-3 | EX-521 | 50 | 1.87 | 120 | 362 | A |
| Ex. 4 | D4550 | r-1 | R-1 | EX-614B | 30 | 0.75 | 120 | 431 | A |
| Ex. 5 | D4550 | r-4 | R-4 | EX-313 | 40 | 0.75 | 100 | 305 | A |
| Ex. 6 | D4550 | r-5 | R-5 | EX-512 | 80 | 2.62 | 75 | 339 | A |
| Ex. 7 | D4550 | r-6 | R-6 | EX-521 | 50 | 0.53 | 100 | 347 | A |
| Ex. 8 | D4550 | r-7 | R-7 | EX-614B | 40 | 1.33 | 25 | 284 | A |
| Ex. 9 | D4550 | r-8 | R-8 | EX-313 | 60 | 1.15 | 100 | 350 | A |
| Ex. 10 | E-S | r-1 | R-1 | EX-512 | 40 | 0.82 | 100 | 338 | A |
| Ex. 11 | E3B | r-3 | R-3 | EX-521 | 50 | 1.87 | 75 | 478 | A |
| CEx. 1 | D4550 | r-1 | R-1 | EX-313 | 40 | 0.82 | 0 | 850 | B |
| CEx. 2 | D4550 | r-1 | R-1 | EX-313 | 40 | 0.82 | 75 | 543 | B |
| CEx. 3 | D4550 | r-2 | R-2 | EX-512 | 80 | 1.19 | 0 | 518 | B |
| CEx. 4 | D4550 | r-3 | R-3 | EX-521 | 50 | 1.87 | 0 | 862 | B |
| CEx. 5 | D4550 | r-1 | R-1 | EX-614B | 30 | 0.75 | 0 | 872 | B |
| CEx. 6 | D4550 | r-1 | R-1 | EX-614B | 20 | 0.5 | 0 | 848 | B |
| CEx. 7 | D4550 | r-1 | R-1 | EX-614B | 20 | 0.5 | 100 | 488 | A |
| CEx. 8 | D4550 | r-1 | R-1 | EX-521 | 100 | 2.66 | 150 | 278 | A |
| CEx. 9 | D4550 | r-1 | R-1 | EX-612 | 70 | 1.69 | 100 | 389 | A |
| CEx. 10 | D4550 | r-2 | R-2 | EX-810 | 50 | 0.5 | 75 | 218 | A |
| CEx. 11 | D4550 | r-3 | R-3 | EX-145 | 60 | 4.91 | 100 | 420 | A |
| CEx. 12 | D4550 | r-4 | R-4 | EX-313 | 40 | 0.75 | 0 | 710 | B |
| CEx. 13 | D4550 | r-5 | R-5 | EX-512 | 80 | 2.62 | 0 | 644 | B |
| CEx. 14 | D4550 | r-6 | R-6 | EX-521 | 50 | 0.53 | 0 | 753 | B |
| CEx. 15 | D4550 | r-8 | R-8 | EX-614B | 60 | 1.99 | 0 | 747 | B |
| CEx. 16 | D4550 | r-9 | R-9 | EX-313 | 40 | 0.75 | 100 | 374 | A |
| CEx. 17 | D4550 | r-10 | R-10 | EX-512 | 80 | 2.62 | 100 | 432 | A |
| CEx. 18 | D4550 | r-11 | R-11 | EX-521 | 50 | 0.53 | 25 | 238 | A |
| CEx. 19 | D4550 | r-12 | R-12 | EX-614B | 60 | 1.99 | 100 | 411 | A |
| CEx. 20 | D4550 | r-13 | R-13 | EX-313 | 40 | 0.75 | 100 | 307 | A |
| CEx. 21 | D4550 | r-14 | R-14 | EX-512 | 80 | 2.62 | 200 | 380 | A |
| CEx. 22 | D4550 | r-15 | R-15 | EX-521 | 50 | 0.53 | 100 | 379 | A |
| CEx. 23 | D4550 | r-16 | R-16 | EX-614B | 60 | 1.99 | 0 | 191 | A |
| CEx. 24 | D4550 | r-17 | R-17 | EX-313 | 40 | 0.75 | 100 | 335 | A |
| CEx. 25 | D4550 | r-18 | R-18 | EX-512 | 80 | 2.62 | 100 | 218 | A |
| CEx. 26 | D4550 | r-19 | R-19 | EX-521 | 50 | 0.53 | 100 | 401 | A |
| CEx. 27 | E-S | r-1 | R-1 | EX-512 | 40 | 0.82 | 0 | 747 | B |
| CEx. 28 | E3B | r-3 | R-3 | EX-521 | 50 | 1.87 | 0 | 758 | B |

### <Evaluations>

Each of the inks in Examples 1 to 11 (Ex. 1 to Ex. 11) and Comparative Examples 1 to 28 (CEx. 1 to CEx. 28) was evaluated in terms of solid content in supernatant liquid, reduction of nozzle clogging, and storage stability in the following manners. The evaluation results are shown in Table 7 below.

### [Solid Content in Supernatant Liquid]

Each of the inks as subjects to evaluation (each of the inks in Examples 1 to 11 and Comparative Examples 1 to 28) was centrifuged in the following manner and the obtained supernatant liquid was measured in terms of content of solid contained therein. Specifically, first, each ink as a subject to evaluation was subjected to centrifugation treatment for three hours at a rotational speed of 140,000 rpm (a centrifugal force of 1,050,000 G) with an ultracentrifuge (“himac (registered trademark) CS150FNX” manufactured by Eppendorf Himac Technologies Co., Ltd., rotor: S140AT). Thus, pigment particles contained in the ink as the subject to evaluation were precipitated.

Next, 30 μL of supernatant liquid contained in the ink after undergoing the centrifugation treatment was transferred to an aluminum container for thermogravimetric measurement. Next, the mass A of 30 μL of supernatant liquid was measured. Next, the supernatant liquid was subjected to thermogravimetry according to the scheme shown in Table 6 below, using a thermogravimetric analyzer (“TG/DTA 7200” manufactured by Hitachi High-Tech Science Corporation) to measure the reduced mass B of the ink as the subject to evaluation between temperatures from 200° C. to 500° C.

TABLE 6

| | Start | Limit | Rate | Hold | |
|---|---|---|---|---|---|
| No. | (° C.) | (° C.) | (° C./min.) | (min.) | Atmosphere |
| 1 | 30 | 80 | 50 | 15 | N₂ |
| 2 | 80 | 200 | 50 | 15 | N₂ |
| 3 | 200 | 500 | 50 | 5 | air |

The reduced mass (B) is assumed to be the mass of solid (consisting mainly of suspended resin) in the supernatant liquid. Using the mass A and the reduced mass B both measured, the content of solid in the supernatant liquid was calculated from the formula (2) below. The calculated content was used as an evaluation value for solid content in supernatant liquid.

$$\begin{matrix}[ Math . 2 ] & \\ Content of solid in supernatant liquid ( \% by mass ) = 100 \times B / A & ( 2 )\end{matrix}$$

### (Evaluation Criteria for Solid Content in Supernatant Liquid)

Each ink was evaluated in terms of solid content in supernatant liquid in accordance with the following criteria.

A (good): The content of solid in supernatant liquid was not more than 2.0% by mass.

B (no good): The content of solid in supernatant liquid was more than 2.0% by mass.

### [Nozzle Clogging]

In the evaluation of reduction of nozzle clogging, A4 ink-jet matte paper (“SuperFine Paper” manufactured by Seiko Epson Corporation) was used as evaluation paper. As an apparatus for evaluation, a line head-mounted ink-jet recording apparatus (a test apparatus produced by KYOCERA Document Solutions Inc.) was used. Each of the inks as subjects to evaluation (each of the inks in Examples 1 to 11 and Comparative Examples 1 to 28) was loaded into a magenta ink tank of the apparatus for evaluation.

First, using the apparatus for evaluation, a solid image with 150 mm×200 mm was continuously printed on 100 sheets of evaluation paper. Next, purge processing for purging the ink as the subject to evaluation from the recording head of the apparatus for evaluation was done. Next, wiping processing for wiping the ink ejection surface of the recording head of the apparatus for evaluation with a cleaning wiper was done, thus cleaning the recording head. Hereinafter, the operation for cleaning the recording head by the purge processing and the wiping processing is referred to as cleaning processing.

Next, using the apparatus for evaluation, a nozzle check pattern image was formed on a sheet of evaluation paper. As a result, in all the cases where the respective inks as subjects to evaluation were used, the ink as a subject to evaluation had been ejected through all the nozzles (7968 nozzles). In other words, the number of nozzles caused clogging (hereinafter, referred to as “non-ejectable nozzles”) was zero. Next, the recording head of the apparatus for evaluation was subjected to the cleaning processing again. Next, the apparatus for evaluation was allowed to stand for seven days with its recording head uncapped. Next, the recording head of the apparatus for evaluation was subjected to the cleaning processing again.

Next, using the apparatus for evaluation, a nozzle check pattern image was formed as an evaluation image on a sheet of evaluation paper. The evaluation image was checked and the percentage of the number of non-ejectable nozzles with respect to the total number of nozzles (7968 nozzles) of the recording head was calculated. The calculated percentage of the number of non-ejectable nozzles was used as an evaluation value for reduction of nozzle clogging.

### (Evaluation Criteria for Reduction of Nozzle Clogging)

Each ink was evaluated in terms of reduction of nozzle clogging in accordance with the following criteria.
A (good): The evaluation value was less than 10%.
B (poor): The evaluation value was 10% or more.

### [Storage Stability]

Each ink as a subject to evaluation (each of the inks in Examples 1 to 11 and Comparative Examples 1 to 28) was measured in terms of viscosity (initial viscosity V1) at 25° C. with a vibratory viscometer (“VM-200T” manufactured by Nittetsu Hokkaido Control Systems Co. Ltd.). Next, approximately 30 g of the ink as a subject to evaluation was introduced into a 50 mL container and the container was hermitically sealed. This container was placed into a constant-temperature unit set at an internal temperature of 60° C. and held therein at the temperature for a month.

Next, the above container was taken out of the constant-temperature unit and allowed to stand at room temperature for three hours. Next, the ink as a subject to evaluation was taken out of the container and measured in terms of viscosity (post-treatment viscosity V2) at 25° C. with the above-mentioned vibratory viscometer. Using the initial viscosity V1 and the post-treatment viscosity V2 both measured, the viscosity change rate (%) was determined from the formula (3) below. The calculated viscosity change rate was used as an evaluation value for storage stability.

$$\begin{matrix}[ Math . 3 ] & \\ Viscosity change rate ( \% ) = 100 \times ( V 1 - V 2 ) / V 1 & ( 3 )\end{matrix}$$

### (Evaluation Criteria for Storage Stability)

Each ink was evaluated in terms of storage stability in accordance with the following criteria.
A (good): The absolute value of the viscosity change rate was less than 5%.
B (poor): The absolute value of the viscosity change rate was 5% or more.

TABLE 7

| | Solid Content in | | | | | |
|---|---|---|---|---|---|---|
| | Supernatant Liquid | | Nozzle Clogging | | Storage Stability | |
| | % by | | Evaluation | | Evaluation | |
| | mass | Determination | value(%) | Determination | value(%) | Determination |
| Ex. 1 | 0.8 | A | 6 | A | 3.8 | A |
| Ex. 2 | 0.7 | A | 6 | A | 3.5 | A |
| Ex. 3 | 0.6 | A | 7 | A | 4.1 | A |
| Ex. 4 | 0.5 | A | 5 | A | 3.8 | A |
| Ex. 5 | 0.8 | A | 8 | A | 4.9 | A |
| Ex. 6 | 0.7 | A | 8 | A | 4.1 | A |
| Ex. 7 | 0.6 | A | 7 | A | 4.3 | A |
| Ex. 8 | 0.6 | A | 7 | A | 4.4 | A |
| Ex. 9 | 0.8 | A | 8 | A | 4.5 | A |
| Ex. 10 | 0.7 | A | 7 | A | 3.9 | A |
| Ex. 11 | 1.0 | A | 8 | A | 4.1 | A |
| CEx. 1 | 1.3 | A | 11 | B | 8.0 | B |
| CEx. 2 | 1.1 | A | 12 | B | 6.4 | B |
| CEx. 3 | 0.8 | A | 13 | B | 6.8 | B |
| CEx. 4 | 1.2 | A | 12 | B | 11.8 | B |
| CEx. 5 | 0.9 | A | 13 | B | 12.4 | B |
| CEx. 6 | 0.5 | A | 15 | B | 13.0 | B |
| CEx. 7 | 0.3 | A | 13 | B | 10.0 | B |
| CEx. 8 | 0.9 | A | 12 | B | 8.0 | B |
| CEx. 9 | 2.2 | A | 15 | B | 12.7 | B |
| CEx. 10 | 1.0 | A | 17 | B | 16.8 | B |
| CEx. 11 | 1.1 | A | 16 | B | 12.8 | B |
| CEx. 12 | 1.2 | A | 9 | A | 7.5 | B |
| CEx. 13 | 1.1 | A | 9 | A | 6.9 | B |
| CEx. 14 | 1.2 | A | 8 | A | 7.2 | B |
| CEx. 15 | 1.3 | A | 9 | A | 7.5 | B |
| CEx. 16 | 0.9 | A | 15 | B | 14.3 | B |
| CEx. 17 | 1.3 | A | 13 | B | 15.0 | B |
| CEx. 18 | 1.7 | A | 12 | B | 8.7 | B |
| CEx. 19 | 1.4 | A | 18 | B | 14.9 | B |
| CEx. 20 | 1.2 | A | 12 | B | 12.0 | B |
| CEx. 21 | 0.0 | A | 13 | B | 13.0 | B |
| CEx. 22 | 1.5 | A | 17 | B | 18.0 | B |
| CEx. 23 | 1.6 | A | 21 | B | 22.0 | B |
| CEx. 24 | 1.3 | A | 11 | B | 12.0 | B |
| CEx. 25 | 0.9 | A | 20 | B | 25.0 | B |
| CEx. 26 | 1.0 | A | 24 | B | 32.0 | B |
| CEx. 27 | 1.2 | A | 14 | B | 10.2 | B |
| CEx. 28 | 1.4 | A | 13 | B | 9.9 | B |

### Examples 1 to 11

In each of the inks in Examples 1 to 11, the pigment was a quinacridone-based pigment (one of D4550, E-S, and E3B). The cross-linked resin was a cross-linked product made of: a specific resin (a neutralized product of one of Resins (R-1) to (R-8)); and a specific cross-linking agent (one of EX-313, EX-512, EX-521, and EX-614B) and the cross-linking rate was not less than 25% and not more than 90%. The concentration of alkali metal ions in the aqueous vehicle was not more than 500 ppm. Furthermore, the solid content of the supernatant liquid was not more than 2.0% by mass. As a result, the inks in Examples 1 to 11 were determined to have excellent initial dispersibility and dispersion stability and to be good in terms of reduction of nozzle clogging and storage stability.

### Comparative Examples 1 to 5, 12 to 15, 27, and 28

In each of the inks in Examples 1 to 5, 12 to 15, 27, and 28, the pigment was a quinacridone-based pigment (one of D4550, E-S, and E3B). The cross-linked resin was a cross-linked product made of: a specific resin (a neutralized product of one of Resins (R-1) to (R-6) and (R-8)); and a specific cross-linking agent (one of EX-313, EX-512, EX-521, and EX-614B) and the cross-linking rate was not less than 25% and not more than 90%. Furthermore, the solid content of the supernatant liquid was not more than 2.0% by mass. However, the concentration of alkali metal ions in the aqueous vehicle was more than 500 ppm. As a result, the inks in Comparative Examples 1 to 5, 12 to 15, 27, and 28 were determined to be poor in terms of reduction of nozzle clogging and storage stability. It can be estimated that since the concentration of alkali metal ions was high, electrostatic repulsion did not work well between pigment particles and, thus, the dispersion stability of the pigment particles became low.

### Comparative Example 6

In the ink in Comparative Example 6, the pigment was a quinacridone-based pigment (D4550). The cross-linked resin was a cross-linked product made of: a specific resin (a neutralized product of Resin (R-1)); and a specific cross-linking agent (EX-614B). Furthermore, the solid content of the supernatant liquid was not more than 2.0% by mass. However, the cross-linking rate of the cross-linked resin was less than 25% and the concentration of alkali metal ions in the aqueous vehicle was more than 500 ppm. As a result, the ink in Comparative Example 6 was determined to be poor in terms of reduction of nozzle clogging and storage stability. It can be estimated that electrostatic repulsion did not work well between pigment particles because of high concentration of alkali metal ions and, additionally, the specific resin became easy to separate from the pigment particles because of excessively low cross-linking rate, resulting in low dispersion stability of the pigment particles.

### Comparative Example 7

In the ink in Comparative Example 7, the pigment was a quinacridone-based pigment (D4550). The cross-linked resin was a cross-linked product made of: a specific resin (a neutralized product of Resin (R-1)); and a specific cross-linking agent (EX-614B). The concentration of alkali metal ions in the aqueous vehicle was not more than 500 ppm. Furthermore, the solid content of the supernatant liquid was not more than 2.0% by mass. However, the cross-linking rate of the cross-linked resin was less than 25%. As a result, the ink in Comparative Example 7 was determined to be poor in terms of reduction of nozzle clogging and storage stability. It can be estimated that since the cross-linking rate was excessively low, the cross-linked resin became easy to separate from the pigment particles and, thus, the dispersion stability of the pigment particles was low.

### Comparative Example 8

In the ink in Comparative Example 8, the pigment was a quinacridone-based pigment (D4550). The cross-linked resin was a cross-linked product made of: a specific resin (a neutralized product of Resin (R-1)); and a specific cross-linking agent (EX-521). The concentration of alkali metal ions in the aqueous vehicle was not more than 500 ppm. Furthermore, the solid content of the supernatant liquid was not more than 2.0% by mass. However, the cross-linking rate of the cross-linked resin was more than 90%. As a result, the ink in Comparative Example 8 was determined to be poor in terms of reduction of nozzle clogging and storage stability. It can be estimated that since the cross-linking rate was excessively high, the hydrophilicity of the cross-linked resin decreased and, thus, the dispersion stability of the pigment particles was low.

### Comparative Example 9

In the ink in Comparative Example 9, the pigment was a quinacridone-based pigment (D4550). The cross-linking rate of the cross-linked resin was not less than 25% and not more than 90% and the concentration of alkali metal ions in the aqueous vehicle was not more than 500 ppm. However, the cross-linked resin was a cross-linked product made of: a specific resin (a neutralized product of Resin (R-1)); and a cross-linking agent (EX-612) having a water solubility of less than 80%. Furthermore, the solid content of the supernatant liquid was more than 2.0% by mass. As a result, the ink in Comparative Example 9 was determined to be poor in terms of reduction of nozzle clogging and storage stability. It can be estimated that since the cross-linking agent was not a specific cross-linking agent, the dispersion stability of the pigment particles was low. Furthermore, it can be estimated that since the solid content in the supernatant liquid was high, nozzle clogging was likely to occur.

### Comparative Examples 10 and 11

In each of the inks in Comparative Examples 10 and 11, the pigment was a quinacridone-based pigment (D4550). The cross-linking rate of the cross-linked resin was not less than 25% and not more than 90% and the concentration of alkali metal ions in the aqueous vehicle was not more than 500 ppm. Furthermore, the solid content of the supernatant liquid was not more than 2.0% by mass. However, the cross-linked resin was a cross-linked product made of: a specific resin (a neutralized product of Resin (R-2) or (R-3)); and a cross-linking agent (EX-810 or EX-145) having no hydroxy group. As a result, the inks in Comparative Examples 10 and 11 were determined to be poor in terms of reduction of nozzle clogging and storage stability. It can be estimated that since the cross-linking agent was not a specific cross-linking agent, the dispersion stability of the pigment particles was low.

### Comparative Examples 16 to 21

In each of the inks in Comparative Examples 16 to 21, the pigment was a quinacridone-based pigment (D4550). The cross-linking rate of the cross-linked resin was not less than 25% and not more than 90% and the concentration of alkali metal ions in the aqueous vehicle was not more than 500 ppm. Furthermore, the solid content of the supernatant liquid was not more than 2.0% by mass. However, the cross-linked resin was a cross-linked product made of: a resin falling outside the category of specific resin (a neutralized product of one of Resins (R-9) to (R-14)); and a specific cross-linking agent (one of EX-313, EX-512, EX-521, and EX-614B). As a result, the inks in Comparative Examples 16 to 21 were determined to be poor in terms of reduction of nozzle clogging and storage stability. It can be estimated that since the respective contents of the first to fourth repeating units in Resins (R-9) to (R-14) fell outside the above respective ranges, the dispersion stability of the pigment particles was low.

### Comparative Examples 22 and 23

In each of the inks in Comparative Examples 22 and 23, the pigment was a quinacridone-based pigment (D4550). The cross-linking rate of the cross-linked resin was not less than 25% and not more than 90% and the concentration of alkali metal ions in the aqueous vehicle was not more than 500 ppm. Furthermore, the solid content of the supernatant liquid was not more than 2.0% by mass. However, the cross-linked resin was a cross-linked product made of: a resin falling outside the category of specific resin (a neutralized product of Resin (R-15) or (R-16)); and a specific cross-linking agent (EX-521 or EX-614B). As a result, the inks in Comparative Examples 22 and 23 were determined to be poor in terms of reduction of nozzle clogging and storage stability. It can be estimated that since the respective contents of the first to fourth repeating units in Resins (R-15) and (R-16) fell outside the above respective ranges and their acid values fell outside the range of not less than 50 mgKOH/g and not more than 300 mgKOH/g, the dispersion stability of the pigment particles was low.

### Comparative Example 24

In the ink in Comparative Example 24, the pigment was a quinacridone-based pigment (D4550). The cross-linking rate of the cross-linked resin was not less than 25% and not more than 90% and the concentration of alkali metal ions in the aqueous vehicle was not more than 500 ppm. Furthermore, the solid content of the supernatant liquid was not more than 2.0% by mass. However, the cross-linked resin was a cross-linked product made of: a resin falling outside the category of specific resin (a neutralized product of Resin (R-17)); and a specific cross-linking agent (EX-313). As a result, the ink in Comparative Example 24 was determined to be poor in terms of reduction of nozzle clogging and storage stability. It can be estimated that since the percentage of neutralization of neutralized Resin (R-17) fell outside the range of not less than 20% and not more than 100%, the hydrophilicity of the cross-linked resin became low and, thus, the dispersion stability of the pigment particles was low.

### Comparative Examples 25 and 26

In each of the inks in Comparative Examples 25 and 26, the pigment was a quinacridone-based pigment (D4550). The cross-linking rate of the cross-linked resin was not less than 25% and not more than 90% and the concentration of alkali metal ions in the aqueous vehicle was not more than 500 ppm. Furthermore, the solid content of the supernatant liquid was not more than 2.0% by mass. However, the cross-linked resin was a cross-linked product made of: a resin falling outside the category of specific resin (a neutralized product of Resin (R-18) or (R-19)); and a specific cross-linking agent (EX-512 or EX-521). As a result, the inks in Comparative Examples 25 and 26 were determined to be poor in terms of reduction of nozzle clogging and storage stability. It can be estimated that since the number average molecular weights (Mn) of Resins (R-18) and (R-19) fell outside the range of not less than 3000 and not more than 18000, the molecular size of the cross-linked resin was not suitable and, therefore, the pigment particles could not be efficiently coated with the cross-linked resin.

### INDUSTRIAL APPLICABILITY

The ink according to this embodiment can be used in order to form an image.

While the present disclosure has been described in detail with reference to the embodiments thereof, it would be apparent to those skilled in the art that the various changes and modifications may be made therein within the scope defined by the appended claims.

What is claimed is:

1. An ink-jet ink containing an aqueous vehicle and pigment particles dispersed in the aqueous vehicle,
the pigment particle containing a pigment and a cross-linked resin,
the pigment being a quinacridone-based pigment,
the cross-linked resin being a cross-linked product made of a specific resin and a specific cross-linking agent,
the specific resin being a neutralized product of a specific copolymer having first repeating units derived from α-methylstyrene, second repeating units derived from styrene, third repeating units derived from (meth)acrylic acid, and fourth repeating units derived from alkylene glycol (meth)acrylate or dialkylene glycol (meth)acrylate,
wherein the specific copolymer has, relative to 100% by mass of all of the first to fourth repeating units, a content of the first repeating unit of not less than 1% by mass and not more than 65% by mass, a content of the second repeating unit of not less than 1% by mass and not more than 60% by mass, a content of the third repeating unit of not less than 10% by mass and not more than 40% by mass, and a content of the fourth repeating unit of not less than 1% by mass and not more than 12% by mass,
the specific copolymer has an acid value of not less than 50 mgKOH/g and not more than 300 mgKOH/g,
the specific copolymer has a number average molecular weight of not less than 3000 and not more than 18000,
the specific resin has a percentage of neutralization of not less than 20% and not more than 100%,
the specific cross-linking agent contains a polyfunctional epoxy compound having, in a molecule thereof, two or more epoxy groups and one or more hydroxy groups and has a water solubility of not less than 80%,
the cross-linked resin has a cross-linking rate of not less than 25% and not more than 90%, and
a concentration of alkali metal ions in the aqueous vehicle is not more than 500 ppm.

2. The ink-jet ink according to claim 1, wherein a content of solid in a supernatant liquid obtained by subjecting the ink-jet ink to centrifugation treatment is not more than 2.0% by mass.

3. The ink-jet ink according to claim 1, wherein the polyfunctional epoxy compound contains at least one of glycerol polyglycidyl ether, polyglycerol polyglycidyl ether and sorbitol polyglycidyl ether.

4. The ink-jet ink according to claim 1, wherein the quinacridone-based pigment is C.I. Pigment Violet (19 or 42), C.I. Pigment Red (122, 202, 206, 207 or 209) or C.I. Pigment Orange (48 or 49).
